(19) United States
(12) Patent Application Publication
(10) Pub. No.: US 2007/0261117 A1
(43) Pub. Date: Nov. 8, 2007

(54) Method and system for detecting a compressed pestware executable object

(76) Inventor: Matthew L. Boney, Longmont, CO (US)

Correspondence Address: COOLEY GODWARD KRONISH LLP;ATTN: PATENT GROUP, Suite 500, 1200 - 19th Street, NW, WASHINGTON, DC, 20036-2402, US

(21) Appl. No.: 11/407,658

(22) Filed: Apr. 20, 2006

(51) Int. Cl. G06F 12/14

(52) U.S. Cl. 726/24

(57) ABSTRACT

A method and system for detecting a compressed pestware executable object is described. In an illustrative embodiment, while a computer is booting up, an attempt by a running process to exit is detected. The running process is prevented from exiting until a pestware detection procedure has been performed. In one embodiment, the pestware detection procedure includes scanning for pestware signatures the portion of executable program memory associated with the suspended running process. In a different embodiment, the pestware detection procedure includes writing to a file at least the portion of executable program memory associated with the running process, after which the running process is permitted to exit. The file can then be scanned for pestware signatures at a convenient time.

### RELATED APPLICATIONS

The present application is related to the following commonly owned and assigned applications: U.S. patent application Ser. No. 11/105,977, Attorney Docket No. WEBR-014/00US, entitled “System and Method for Scanning Memory for Pestware Offset Signatures”; and U.S. patent application Ser. No. 11/106,122, Attorney Docket No. WEBR-018/00US, entitled “System and Method for Scanning Memory for Pestware”; both of which are incorporated herein by reference.

### FIELD OF THE INVENTION

The present invention relates to protecting computers against pestware or malware. More specifically, but without limitation, the present invention relates to techniques for detecting a compressed pestware executable object that unpacks itself at startup; runs briefly, altering the system; and then exits.

### BACKGROUND OF THE INVENTION

Protecting personal computers against a never-ending onslaught of “pestware” such as viruses, Trojan horses, spyware, adware, and downloaders on personal computers has become vitally important to computer users. Some pestware is merely annoying to the user or degrades system performance. Other pestware is highly malicious. Still other pestware might even be beneficial to the user. Many computer users depend on anti-pestware software that attempts to detect and remove pestware automatically.

Anti-pestware software typically scans running processes in memory and files contained on storage devices such as disk drives, comparing them, at expected locations, against a set of “signatures” that identify specific, known types of pestware.

Some types of pestware evade conventional pestware detection techniques, however. For example, a compressed or packed pestware executable object residing on a storage device of a computer may unpack itself while the computer is starting up, execute long enough to do harm or otherwise alter the system, and then exit. Such pestware may, for example, download files from the Internet, infecting or re-infecting the system, during the brief time it executes. Because the compressed pestware executable object is compressed (or even encrypted), a conventional anti-pestware scan of the storage device on which it resides fails to detect it. Because the running process associated with the compressed pestware executable object is resident in executable program memory for only a brief period, a conventional scan of executable program memory also fails to detect it.

One conventional approach to detecting a compressed pestware executable object is to analyze the unpacking routine within the compressed pestware executable object and to attempt to unpack it to scan for pestware signatures. Unfortunately, this approach is time consuming, especially on a storage volume containing many compressed files, and it is not always reliable.

It is thus apparent that there is a need in the art for an improved method and system for detecting a compressed pestware executable object.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The present invention can provide a method and system for detecting a compressed pestware executable object. One illustrative embodiment is a method for detecting a compressed pestware executable object on a computer, comprising detecting, during startup of the computer, that a running process is attempting to exit; and preventing the running process from exiting until a pestware detection procedure has been performed.

Another illustrative embodiment is a system for detecting a compressed pestware executable object on a computer, comprising a driver configured to detect, during startup of the computer, that a running process is attempting to exit; and to prevent the running process from exiting until a pestware detection procedure has been performed. These and other embodiments are described in further detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings, wherein:

FIG. 1A is a high-level functional block diagram of a computer protected by an anti-pestware system, in accordance with an illustrative embodiment of the invention;

FIG. 1B is a diagram of a memory of the computer shown in FIG. 1A, in accordance with an illustrative embodiment of the invention;

FIG. 2 is a flowchart of a method for detecting a compressed pestware executable object, in accordance with an illustrative embodiment of the invention;

FIG. 3 is a flowchart of a method for detecting a compressed pestware executable object, in accordance with another illustrative embodiment of the invention;

FIG. 4 is a flowchart of a method for detecting a compressed pestware executable object, in accordance with another illustrative embodiment of the invention;

FIG. 5 is a flowchart of a method for detecting a compressed pestware executable object, in accordance with yet another illustrative embodiment of the invention; and

FIG. 6 is a flowchart of a method for preventing a running process from exiting until a pestware detection procedure has been performed, in accordance with another illustrative embodiment of the invention.

### DETAILED DESCRIPTION

“Pestware,” as used herein, refers to any program that damages or disrupts a computer system or that collects or reports information about a person or an organization. Examples include, without limitation, viruses, worms, Trojan horses, spyware, adware, and downloaders.

In an illustrative embodiment, a compressed pestware executable object is detected by detecting, while the computer is starting up, that a running process is attempting to exit and by preventing the running process from exiting until a pestware detection procedure has been performed. In this way, an anti-pestware system can gain access to the unprotected program code of a running process associated with a compressed pestware executable object without having to ascertain how to unpack the compressed pestware executable object. Legitimate processes are merely delayed in exiting for a brief period that depends on the particular embodiment.

The pestware detection procedure that is performed while the running process is prevented from exiting can take a variety of forms. In one illustrative embodiment, the pestware detection procedure includes scanning for pestware signatures the portion of executable program memory associated with the suspended running process. If such signatures are found, corrective action can be taken such as removing the compressed pestware executable object from the computer. In another illustrative embodiment, the pestware detection procedure includes writing to a file at least the portion of executable program memory associated with the running process, after which the running process is permitted to exit. A detection module of the anti-pestware system can then scan the file for pestware signatures at a convenient time.

Optionally, the above illustrative embodiments can be supplemented with additional techniques. For example, while the running process is being prevented from exiting, a record can be made of any changes it has made to the system since being launched. If it is later determined that the running process is associated with a compressed pestware executable object, the record or log of changes can be used to inspect the computer for damage. In some situations, such damage is correctible.

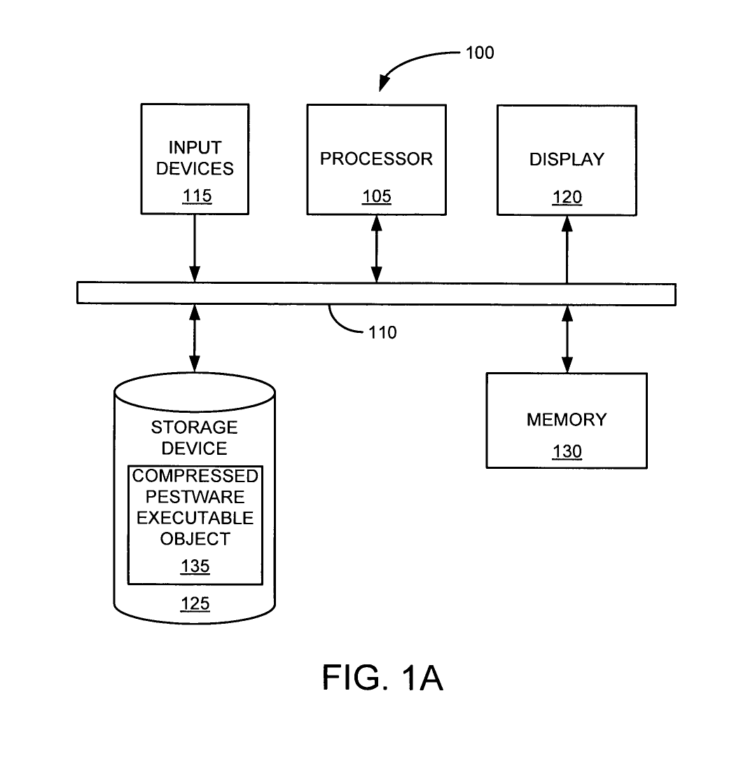

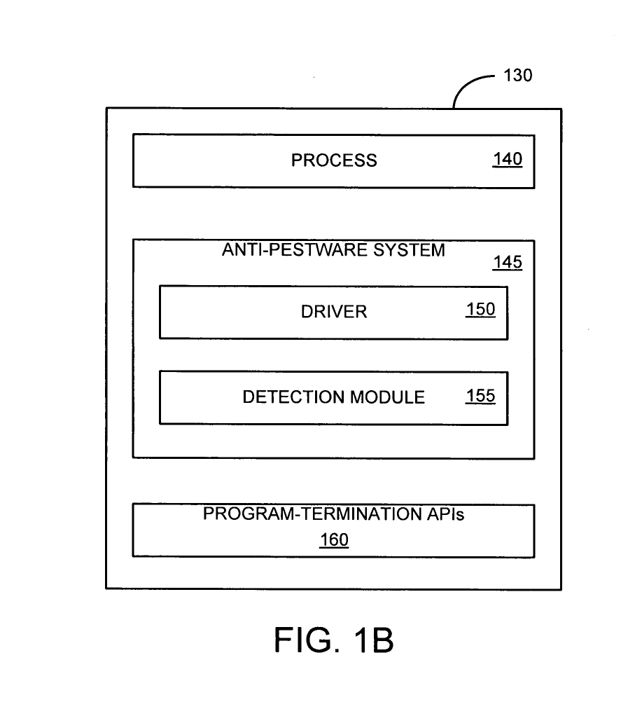

Referring now to the drawings, where like or similar elements are designated with identical reference numerals throughout the several views, FIG. 1A is a high-level functional block diagram of a computer 100 protected by an anti-pestware system, in accordance with an illustrative embodiment of the invention. Computer 100 can be a desktop computer, workstation, laptop computer, notebook computer, handheld computer, or any other device that includes computing functionality. In FIG. 1A, processor 105 communicates over data bus 110 with input devices 115, display 120, storage device 125, and memory 130. The anti-pestware system of computer 100 is designed to protect computer 100 against, among other things, compressed pestware executable object 135, which is shown in FIG. 1A as residing on storage device 125.

Input devices 115 may be, for example, a keyboard and a mouse or other pointing device. In an illustrative embodiment, storage device 125 is a magnetic-disk device such as a hard disk drive (HDD). In other embodiments, however, storage device 125 can be any type of computer storage device, including, without limitation, a magnetic-disk drive, an optical-disc drive, and a storage device employing flash-memory-based media such as secure digital (SD) cards or multi-media cards (MMCs). Memory 130 may include random-access memory (RAM), read-only memory (ROM), or a combination thereof.

FIG. 1B is a diagram of memory 130 of computer 100 shown in FIG. 1A, in accordance with an illustrative embodiment of the invention. In FIG. 1B, memory 130 contains an arbitrary running process (“process”) 140 that is launched at startup; anti-pestware system 145, which includes driver 150 and detection module 155; and program-termination application program interfaces (APIs) 160.

Anti-pestware system 145 protects computer 100 against pestware by detecting it and, when appropriate, removing it from computer 100. In the illustrative embodiment of FIG. 1B, anti-pestware system 145 is an application program stored on a computer-readable storage medium of computer 100 (e.g., storage device 125) that can be loaded into memory 130 and executed by processor 105. In other embodiments, the functionality of anti-pestware system 145 can be implemented in software, firmware, hardware, or any combination thereof.

For convenience in this Detailed Description, the functionality of anti-pestware system 145 has been divided into two functional portions, driver 150 and detection module 155. In various embodiments of the invention, the functionality of driver 150 and detection module 155 may be combined or subdivided in different ways.

As mentioned above, process 140 is launched during the startup of computer 100. At some point shortly after its launch, process 140 may attempt to exit. Such behavior occurs with both pestware and legitimate running processes. In such a situation, driver 150 prevents process 140 from exiting until a pestware detection procedure has been performed. To accomplish this objective, driver 150 is configured to be loaded by the operating system of computer 100 into memory 130 at the earliest possible time during startup. Those skilled in the art will recognize that drivers are loaded during startup before both system services (e.g., APIs) and user applications.

Driver 150 is configured to intercept and suspend kernel-level calls to terminate running processes 140 during the startup of computer 100. In an illustrative embodiment, driver 150 hooks one or more program-termination APIs 160 of the operating system. “Hooking” an API is a concept that is well known in the computer programming art. As those skilled in the art are aware, hooking may be used to monitor and intercept events (e.g., API calls) in computer 100. For example, operating systems sold by Microsoft Corporation under the trade name “Windows” (e.g., “Windows XP”) provide an “ExitProcess” API for terminating a program. Driver 150 can hook this and other Windows program-termination APIs 160. In other embodiments, the specific program-termination APIs 160 that are hooked may differ, depending on the particular operating system.

When a process 140 exits, it calls a program-termination API 160. The operating system of computer 100, in turn, issues a termination request to the kernel (the core portion of the operating system). In one illustrative embodiment, driver 150 intercepts the kernel-level call to terminate the process 140 and temporarily suspends it by not passing it to the kernel. Once the desired pestware detection procedure has been completed, driver 150 permits the kernel-level exit call to proceed, terminating process 140. Such temporary suspension of program-termination APIs 160 does not disrupt computer 100 because the above action is taken only when a process 140 is ready to exit anyway, and the delay required for the pestware detection procedure can be made brief.

Detection module 155 is, in general, a part of anti-pestware system 145 that detects pestware on computer 100. Anti-pestware system 145 may also include a separate module (not shown in FIG. 1B) for removing pestware from computer 100 once detection module 155 has detected pestware on computer 100. In some embodiments, the functionality of pestware detection and removal are combined in a single functional module such as detection module 155.

Detection module 155 detects pestware by scanning executable program memory (e.g., memory 130), storage devices such as storage device 125, or both for signatures or known identifying characteristics. In one illustrative embodiment, detection module 155 scans the portion of executable program memory (e.g., the relevant portion of memory 130) associated with a process 140 while driver 150 is preventing process 140 from exiting. In a different illustrative embodiment, detection module 155 writes to a file (e.g., on storage device 125) at least the portion of executable program memory associated with process 140 while driver 150 is preventing process 140 from exiting, after which driver 150 permits process 140 to exit. The file may be linked, for example, to the particular process ID of process 140. Detection module 155 can then scan this file at a convenient time.

In either of the illustrative embodiments just described, detection module 155 may also, while driver 150 is preventing the process 140 from exiting, record any changes the process 140 has made to computer 100 since it was launched. Once a pestware detection procedure has revealed that process 140 is associated with a compressed pestware executable object 135, detection module 155 can use the recorded changes (e.g., in a log file) to inspect computer 100 for damage associated with those changes. If it is possible to correct the damage, anti-pestware system 145 can correct it.

In scanning executable program memory for pestware signatures, detection module 155 may employ techniques such as offset scanning. Offset scanning and other memory scanning techniques are described in the commonly owned and assigned patent applications listed above and incorporated by reference under “Related Applications.”

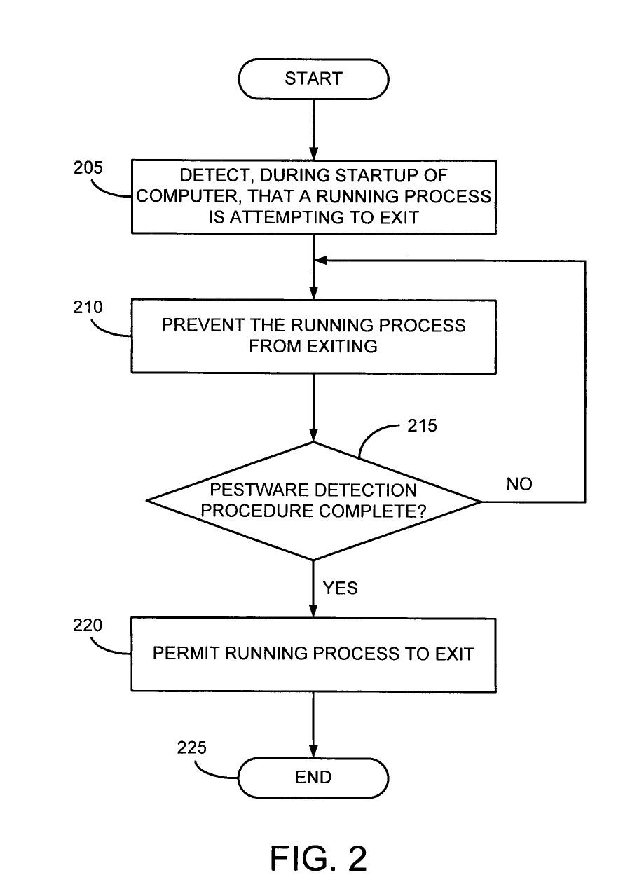

FIG. 2 is a flowchart of a method for detecting a compressed pestware executable object 135, in accordance with an illustrative embodiment of the invention. At 205, driver 150, during the startup of computer 100, detects that a process 140 is attempting to exit. At 210, driver 150 prevents process 140 from exiting. Once a pestware detection procedure has been completed at 215, driver 150 permits process 140 to exit at 220, and the process terminates at 225.

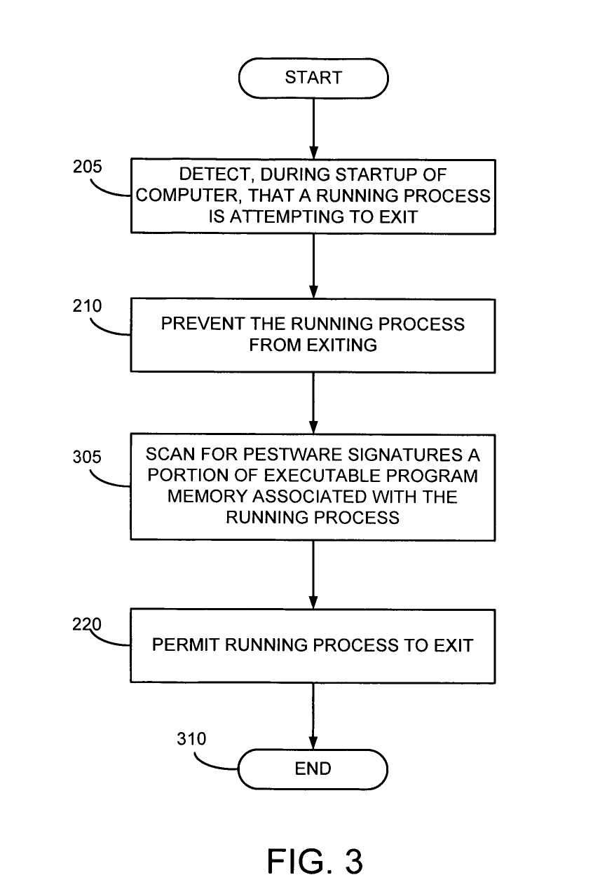

FIG. 3 is a flowchart of a method for detecting a compressed pestware executable object, in accordance with another illustrative embodiment of the invention. In the embodiment of FIG. 3, detection module 155, at 305, scans for pestware signatures a portion of the executable program memory of computer 100 that is associated with process 140. In other words, detection module 155 scans the program code of process 140 within the executable program memory of computer 100 (e.g., in memory 130). Detection module 155 performs this pestware detection procedure while driver 150 continues to prevent process 140 from exiting. The steps of the method other than 305 are the same as in FIG. 2.

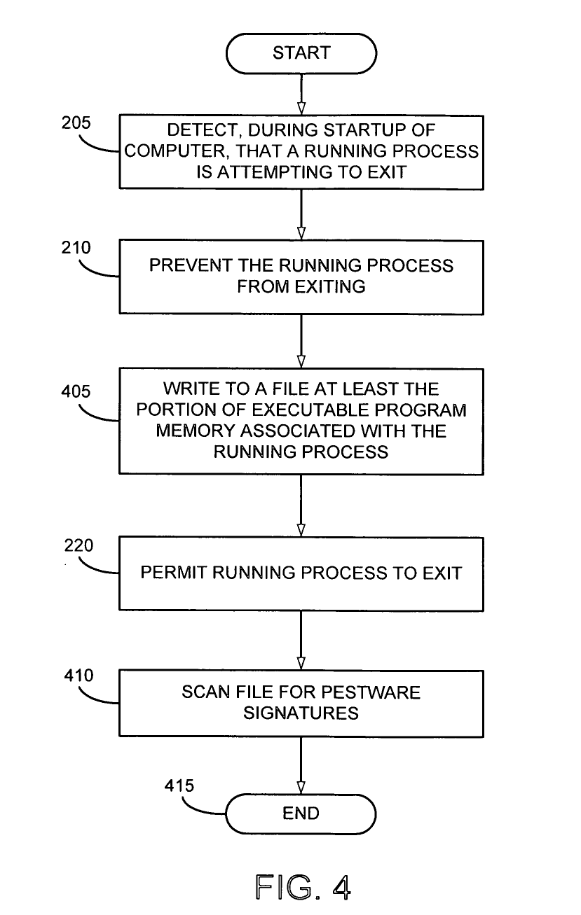

FIG. 4 is a flowchart of a method for detecting a compressed pestware executable object 135, in accordance with another illustrative embodiment of the invention. At 405, detection module 155 writes to a file at least the portion of the executable program memory of computer 100 that is associated with process 140. Sometime after driver 150 has permitted process 140 to exit at 220, detection module 155, at 410, scans for pestware signatures the program code associated with process 140 contained in the file. The remaining steps of the method are the same as in FIG. 2.

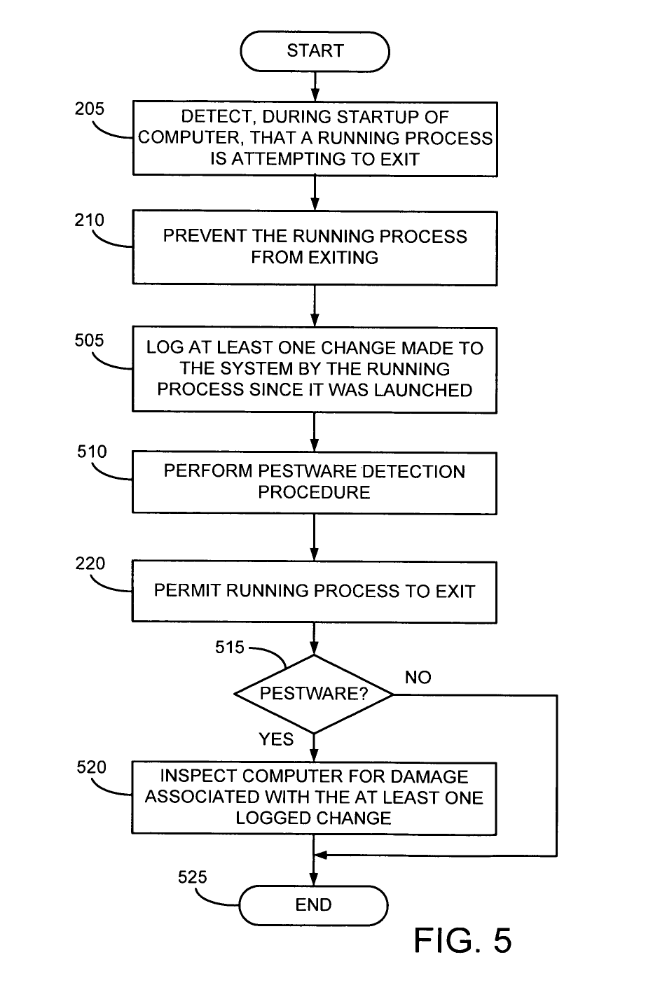

FIG. 5 is a flowchart of a method for detecting a compressed pestware executable object, in accordance with yet another illustrative embodiment of the invention. FIG. 5 illustrates optional steps that can be added to the embodiments in FIGS. 2, 3, and 4. At 505, detection module 155 logs changes to computer 100 made by process 140 since process 140 was launched. At 510, detection module 155 performs a pestware detection procedure such as that shown at Step 305 in FIG. 3 or at Step 405 in FIG. 4. If, at 515, detection module 155 has determined that process 140 is associated with a compressed pestware executable object 135, detection module 155, at 520, inspects computer 100 for damage associated with the logged changes. The process terminates at 525.

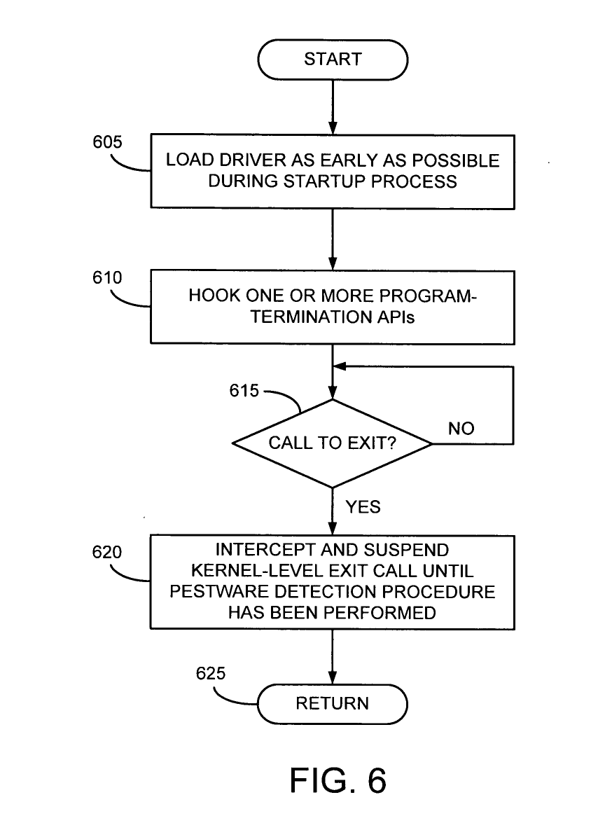

FIG. 6 is a flowchart of a method for preventing a process 140 from exiting until a pestware detection procedure has been performed, in accordance with another illustrative embodiment of the invention. The steps of FIG. 6 may be incorporated at, for example, Step 210 in FIGS. 2, 3, 4, and 5. At 605, driver 150 is loaded into memory 130 at the earliest possible time during the startup process of computer 100. At 610, driver 150 hooks one or more program-termination APIs 160 of the operating system of computer 100. If driver 150 detects a call to a program-termination API 160 at 615, driver 150 intercepts and suspends the associated kernel-level exit call until the pestware detection procedure has been performed. At 625, the method proceeds to the appropriate step in, e.g., FIG. 2, 3, 4, or 5.

In conclusion, the present invention provides, among other things, a method and system for detecting a compressed pestware executable object. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims. For example, though the Windows operating system has been mentioned specifically, the principles of the invention can be applied to other operating systems such as Linux.

What is claimed is:

1. A method for detecting a compressed pestware executable object on a computer, the method comprising:
detecting, during startup of the computer, that a running process is attempting to exit; and
preventing the running process from exiting until a pestware detection procedure has been performed.

2. The method of claim 1, wherein the pestware detection procedure includes scanning for pestware signatures a portion of an executable program memory of the computer that is associated with the running process.

3. The method of claim 1, wherein the pestware detection procedure includes writing to a file on a storage device of the computer at least a portion of an executable program memory of the computer that is associated with the running process.

4. The method of claim 3, further comprising:
scanning the file for pestware signatures after the running process has been permitted to exit.

5. The method of claim 1, further comprising: logging, before the running process is permitted to exit, at least one change the running process has made to the computer since the running process was launched; and
inspecting the computer for damage associated with the at least one logged change when it has been determined that the running process is associated with a compressed pestware executable object.

6. The method of claim 1, wherein preventing the running process from exiting until the pestware detection procedure has been performed includes:
loading, during the startup of the computer, a driver at an earliest possible time permitted by an operating system of the computer;
hooking, with the driver, at least one program-termination application program interface (API) of the operating system;
intercepting, with the driver, a kernel-level call to terminate the running process, the kernel-level call being associated with a program-termination API; and
suspending, with the driver, the kernel-level call until the pestware detection procedure has been performed.

7. A system for detecting a compressed pestware executable object on a computer, the system comprising:
a driver configured to:
detect, during startup of the computer, that a running process is attempting to exit; and prevent the running process from exiting until a pestware detection procedure has been performed.

8. The system of claim 7, further comprising:
a pestware detection module configured to scan for pestware signatures a portion of an executable program memory of the computer that is associated with the running process, while the driver is preventing the running process from exiting.

9. The system of claim 7, further comprising:
a pestware detection module configured to write to a file on a storage device of the computer at least a portion of an executable program memory of the computer that is associated with the running process, while the driver is preventing the running process from exiting.

10. The system of claim 9, wherein the pestware detection module is further configured to scan the file for pestware signatures after the driver has permitted the running process to exit.

11. The system of claim 7, further comprising:
a pestware detection module configured to:
record, while the driver is preventing the running process from exiting, at least one change the running process has made to the computer since the running process was launched; and
inspect the computer for damage associated with the at least one recorded change when the pestware detection module has determined that the running process is associated with a compressed pestware executable object.

12. The system of claim 7, wherein the driver is configured to:
become operative, during the startup of the computer, at an earliest possible time permitted by an operating system of the computer;
hook at least one program-termination application program interface (API) of the operating system;
intercept a kernel-level call to terminate the running process, the kernel-level call being associated with a program-termination API; and
suspend the kernel-level call until the pestware detection procedure has been performed.

13. A system for detecting a compressed pestware executable object on a computer, the system comprising:
means for determining, during startup of the computer, that a running process is attempting to exit; and
means for preventing the running process from exiting until a pestware detection procedure has been performed.

14. The system of claim 13, further comprising:
means for scanning for pestware signatures a portion of an executable program memory of the computer that is associated with the running process, while the running process is being prevented from exiting.

15. The system of claim 13, further comprising:
means for writing to a file on a storage device of the computer at least a portion of an executable program memory of the computer that is associated with the running process, while the running process is being prevented from exiting.

16. The system of claim 15, further comprising:
means for scanning the file for pestware signatures after the running process has been permitted to exit.

17. A computer-readable storage medium containing program instructions to detect a compressed pestware executable object on a computer, the computer-readable storage medium comprising:
a first code segment configured to detect, during startup of the computer, that a running process is attempting to exit; and
a second code segment configured to prevent the running process from exiting until a pestware detection procedure has been performed.

18. The computer-readable storage medium of claim 17, further comprising:
a third code segment configured to scan for pestware signatures a portion of an executable program memory of the computer that is associated with the running process, while the second code segment is preventing the running process from exiting.

19. The computer-readable storage medium of claim 17, further comprising:
a third code segment configured to write to a file on a storage device of the computer at least a portion of an executable program memory of the computer that is associated with the running process, while the second code segment is preventing the running process from exiting.

20. The computer-readable storage medium of claim 19, wherein the third code segment is further configured to scan the file for pestware signatures after the second code segment has permitted the running process to exit.
